(19) United States
(12) Patent Application Publication
(10) Pub. No.: US 2014/0009807 A1
(43) Pub. Date: Jan. 9, 2014

(54) METHOD AND APPARATUS FOR SPACE DIVISION MULTIPLEXED COLOR HOLOGRAPHIC DISPLAY

(71) Applicants: Yuechao Pan, Singapore (SG); Xuewu Xu, Singapore (SG); Sanjeev Solanki, Singapore (SG); Xinan Liang, Singapore (SG); Zhiming Abel Lum, Singapore (SG)

(72) Inventors: Yuechao Pan, Singapore (SG); Xuewu Xu, Singapore (SG); Sanjeev Solanki, Singapore (SG); Xinan Liang, Singapore (SG); Zhiming Abel Lum, Singapore (SG)

(21) Appl. No.: 13/542,562

(22) Filed: Jul. 5, 2012

(51) Int. Cl. G03H 1/08

(52) U.S. Cl. 359/9

(57) ABSTRACT

Methods and an apparatus for color holographic display are provided. The method for color holographic display includes modifying a plurality of color component light beams by passing light from each of a plurality of color component light sources through a corresponding one of a plurality of color sub-hologram masks to generate a corresponding plurality of modified color component light beams. The plurality of modified color component light beams are color multiplexed to generate a multiplexed masked color light beam. The multiplexed masked color light beam is shined onto modulated computer generated holographic information corresponding to the object in order to reconstruct the object by diffracting each portion of the multiplexed masked color light beam to a location and at an intensity determined in response to a corresponding portion of the computer generated holographic information to create the object as a color holographic display.

### FIELD OF THE INVENTION

The present invention generally relates to color holographic displays, and more particularly relates to a method and an apparatus for space division multiplexed color holographic displays.

### BACKGROUND OF THE DISCLOSURE

The ability to display color three-dimensional (3D) objects is a desirable characteristic when developing a 3D holography system. A color holographic display provides a greatly improved sense of reality from reconstructed 3D objects as compared to mono-color reconstructed images. However, holography uses diffraction to reconstruct 3D objects, and holography requires single or narrow band wavelength reference light for good depth feeling. Also, holography is not a direct image of a hologram, making most color technologies used for two-dimensional displays unsuitable for 3D color holography.

Creating color in a display consists of two parts: color multiplexing and color mixing. Color multiplexing refers to selection of the correct color components for reconstruction. For example, one input 3D object point has red (R), green (G) and blue (B) color components such as a_{R}, a_{G} and a_{B}. In reconstruction of an image for display, these color components should be equivalent to a_{R}, a_{G} and a_{B}, not a_{G}, a_{B} and a_{R} or other combinations. Correct selection of color components requires both the generation of holograms and the color reconstruction using an optical system to work with each other. Color mixing reconstructs different color components of the same 3D object point at the same position as specified by an input. Without color mixing, reconstruction will be color-separated or blurred.

Drawbacks of conventional holographic color display systems include color hologram generation that is computationally expensive, while providing inconsistent color reconstruction quality. Conventional systems also typically meet or exceed bandwidth and storage limitations because a required spatial light modulator and a storage device for hologram data each have their own refresh rate, bandwidth, and capacity limitations, as well as separate launching hardware and computer requirements. Further, conventional systems are typically complicated systems that are difficult to manage and expensive to operate.

Thus, what is needed is a 3D color holographic system with low computational load requirements, low bandwidth and low storage requirements, simple system design and control, and good color reconstruction quality. Furthermore, other desirable features and characteristics will become apparent from the subsequent detailed description and the appended claims, taken in conjunction with the accompanying drawings and this background of the disclosure.

### SUMMARY

According to the Detailed Description, a method for color holographic display is provided. The method for color holographic display includes modifying a plurality of color component light beams by passing light from each of a plurality of color component light sources through a corresponding one of a plurality of color sub-hologram masks to generate a corresponding plurality of modified color component light beams. The method also includes multiplexing the plurality of modified color component light beams to generate a multiplexed masked color light beam and creating a color holographic display of a three-dimensional object by shining the multiplexed masked color light beam onto modulated computer generated holographic information corresponding to the object in order to reconstruct each point of the object with a color from a portion of the multiplexed masked color light beam and at a location and intensity determined in response to a corresponding portion of the computer generated holographic information.

In accordance with another aspect, an additional method for color holographic display is provided. This method for color holographic display includes combining a plurality of color component light beams from each of a plurality of color component light sources to generate a multiplexed color light beam and modifying the multiplexed color light beam by filtering the multiplexed color light beam to generate a multiplexed masked color light beam. The method further includes creating a color holographic display of a three-dimensional object by shining the multiplexed masked color light beam onto modulated computer generated holographic information corresponding to the object in order to reconstruct the object by combining each portion of the multiplexed masked color light beam at a location and an intensity determined in response to a corresponding portion of the computer generated holographic information.

In accordance with yet another aspect, a method for generating a plurality of points for a color holographic display in a reconstructed object space of a three-dimensional object in a three-dimensional object space is provided. The method for generating the plurality of points of the color holographic display includes determining modulation values for each of a plurality of pixels in a two-dimensional representation of the three-dimensional object in response to locations and color intensity values of each of the plurality of points of the object in the three-dimensional object space and providing the modulation values for each of the plurality of pixels as computer generated holographic information to a spatial light modulator. The method further includes combining each of the modulation values with a corresponding predetermined wavelength of light by shining a multiplexed color light beam on the spatial light modulator programmed with the computer generated holographic information in order to generate the color holographic display of the three-dimensional object in the reconstructed object space.

In accordance with a further aspect, a color holographic display system is provided. The color holographic display system includes a plurality of component light sources, one or more light modifiers and a spatial light modulator. The one or more light modifiers are coupled to the plurality of light sources and generate a modified masked multiplexed light beam from light beams generated by and radiated from the plurality of component light sources. The one or more light modifiers include one or more light modifiers such as light masks, wavelength bandpass filters and light beam color multiplexer structures. The spatial light modulator receives computer generated holographic information and varies modulation of the modified masked multiplexed light beam shined on the spatial light modulator in response to the computer generated holographic information to create a color holographic display of a three-dimensional object by reconstructing the object through modulating the multiplexed masked color light beam at locations determined in response to the computer generated holographic information within a three-dimensional reconstructed object space.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with the present invention.

FIG. 1 illustrates a space division multiplexing (SDM) computer generated hologram (CGH) process in accordance with a present embodiment.

FIG. 2 illustrates a process for generation of CGH holographic information for the SDM process of FIG. 1 in accordance with the present embodiment.

FIG. 3 illustrates an optical setup for SDM color holography in accordance with the present embodiment.

FIG. 4 illustrates an optical setup for multiplexing to generate a multiplexed masked color light beam for SDM color holography in accordance with the present embodiment.

FIG. 5 illustrates an alternate embodiment for an optical setup for multiplexing in accordance with the present embodiment.

FIG. 6 illustrates a process for developing a reference light mask for a spatial light modulator for use in the multiplexing of FIG. 4 in accordance with the present embodiment.

FIG. 7 illustrates an exemplary one color mask for use in the process of FIG. 6 in accordance with the present embodiment.

FIG. 8 illustrates an object space correction process in accordance with the present embodiment.

FIG. 9, including FIGS. 9A, 9B and 9C, illustrate exemplary column, row and depth patterns as reference images for object correction utilization in the object space correction process of FIG. 8 in accordance with the present embodiment.

FIG. 10, including FIGS. 10A and 10B, depicts flow diagrams of the object space correction process of FIG. 8 in accordance with the present embodiment.

FIG. 11 illustrates a graph depicting the speed up of processing time for SDM color holography in accordance with the present embodiment as compared to conventional time division multiplexing (TDM) color holography as plotted over the number of object points generated.

FIG. 12 illustrates a graph depicting the speed up of processing time for SDM color holography in accordance with the present embodiment as compared to conventional TDM color holography as plotted over the number of vertical lines generated.

And FIG. 13, including FIGS. 13A and 13B, depict graphs of reconstruction intensity versus viewing angle of conventional TDM color holography and SDM color holography in accordance with the present invention, wherein FIG. 13A depicts a graph of the reconstruction intensity versus the viewing angle for a TDM color holography optical setup that does not include a mask and FIG. 13B depicts a graph of the reconstruction intensity versus the viewing angle for a SDM color holography optical setup in accordance with the present embodiment that includes a mask.

Skilled artisans will appreciate that elements in the figures are illustrated for simplicity and clarity and have not necessarily been drawn to scale. For example, the dimensions of some of the elements in the figures illustrating integrated circuit architecture may be exaggerated relative to other elements to help to improve understanding of the present and alternate embodiments.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

While there are many conventional color holography display systems, these conventional display systems have drawbacks which hamper utilization of such systems. For example, a space division multiplexing (SDM) color holography system on multiple holograms generates one hologram for each of the three color components (red (R), green (G), and blue (B)), and launches these holograms to three individual spatial light modulators (SLMs). Each SLM is shined with a corresponding color reference light in accordance with the hologram launched to it. Different color reconstructions from the three SLMs at different positions of the optical system are optically combined. This conventional SDM color holography system on multiple holograms implementation, however, combines different reconstruction spaces thereby requiring a careful design of the optical system for display of such color holograms. While an SDM on multiple holograms implementation has no requirement for synchronization, such system requires increased computer generated hologram (CGH) computational load and hologram storage/transmission bandwidth three times that required for traditional single color holography.

Time Division Multiplexing (TDM) color holography display systems are another conventional method for color holography. Holograms for different color components are launched on an SLM sequentially and, when a hologram for one color component is launched, only the reference light for that color turns on. While there is only one reconstruction space and thus no optical combination is needed, TDM color holography display systems impose a two-times higher refresh rate requirement on the SLM device as compared to traditional single color holography or an SDM on multiple holograms color holography display system. The CGH computational load and hologram storage/transmission bandwidth are also three times that of single color holography.

A third type of conventional color holography display system is a SDM on single hologram (three quarters) color holography display system. Instead of implementing SDM on multiple holograms, this conventional technique utilizes different portions of the same hologram for different colors. SDM on single hologram (three quarters) divides a hologram into four sub-holograms, where different color components are launched on each sub-hologram and shined with reference light of a corresponding color. Although sub-holograms are implemented on a single SLM, each of the different colors still have different reconstruction spaces and it is difficult to combine these shifted reconstruction spaces. Shifting by hologram computation may be utilized to combine the reconstruction spaces, but the hologram has defection angle limitations. Thus, eventually the utilizable reconstruction space for combining each color is reduced to around one quarter of the reconstruction space provided by traditional single color holography. While mixing can be achieved by capturing a full color reconstruction projected on a capturing device such as a charge-coupled device (CCD) image sensor, when viewed by human eyes it is likely that a fixed portion of the reconstruction space would only show one color. None of these drawbacks is balanced by processing, storage or transmission savings because the CGH computational load and hologram storage/transmission bandwidth for a conventional SDM on single hologram (three quarters) system is the same as the requirements for a single color holography.

Another conventional spatial division multiplexing method used for color holography is angular multiplexing; more specifically an SDM on single hologram (angular selective) color holography system. In this fourth type of conventional color holography system, holograms for different color components are computed with reference light with different incident angles and superimposed to form a final hologram for all colors. During the reconstruction process, the color reference light shines the hologram at the same angles used for the CGH computation. Different color output light will have different output angles from the SLM, so combining different color reconstruction and optical design are difficult. Further, the CGH computational load for this method is around three times the load for traditional single color holography, while hologram storage/transmission bandwidth remains the same.

The drawbacks of these conventional systems is summarized in Table 1:

TABLE 1

| Color | CGH | Bandwidth/ | Optical | |
|---|---|---|---|---|
| multiplexing | computation | storage | setup | Reconstruction |
| method | load | requirement | complexity | quality |
| SDM on | 3x | 3x | Complex, | 3 |
| multiple | | | No Sync | reconstruction |
| holograms | | | | spaces, |
| | | | | hard to mix |
| TDM | 3x | 3x | Simple, | Full |
| | | | Need Sync | reconstruction |
| | | | | space, |
| | | | | easy to mix |
| SDM on | 1x | 1x | Simple, | 3 x ¼ |
| single | | | No Sync | reconstruction |
| hologram (3 | | | | spaces, |
| quarters) | | | | hard to mix |
| SDM on | 3x | 1x | Complex, | 3 |
| single | | | No Sync | reconstruction |
| hologram | | | | spaces, |
| (angular | | | | hard to mix |
| selective) | | | | |

One method for color mixing in a color holographic display is by theoretically analyzing and numerically correcting distortion and mismatch introduced by each optical element in the holographic reconstruction setup, one by one. This is typically termed element by element correction. While element by element correction can provide accurate correction results because it is specific to the individual holographic reconstruction system, slight changes like angle or position change of a component will require a different set of correction values. While correction can be done at the element level, such correction is computationally tedious and time consuming. The drawbacks of such an element by element correction system are shown in Table 2 below:

TABLE 2

| Color mixing | Analysis | | | Reconstruction |
|---|---|---|---|---|
| method | focus | Nature | Complexity | quality |
| Element-by- | Element | Theoretical | Complex | Accurate |
| element | | | | |
| correction | | | | |

In accordance with a present embodiment, a new space division multiplexing on a single SLM for color holographic three-dimensional display (referred to as SDM on single hologram (distributed sub-hologram)) is presented. The present embodiment, as will be seen from the description hereinbelow, distributes three sub-holograms for each of three color components, red (R), green (G) and blue (B), of a three-dimensional object on a single hologram. After shining on these sub-holograms a multiplexed masked color light beam generated by modifying a plurality of color component light beams by correspondingly masking reference light sources, reconstructions of different color components of the three-dimensional object will be automatically combined in a reconstructed object space to create a color holographic display of the object.

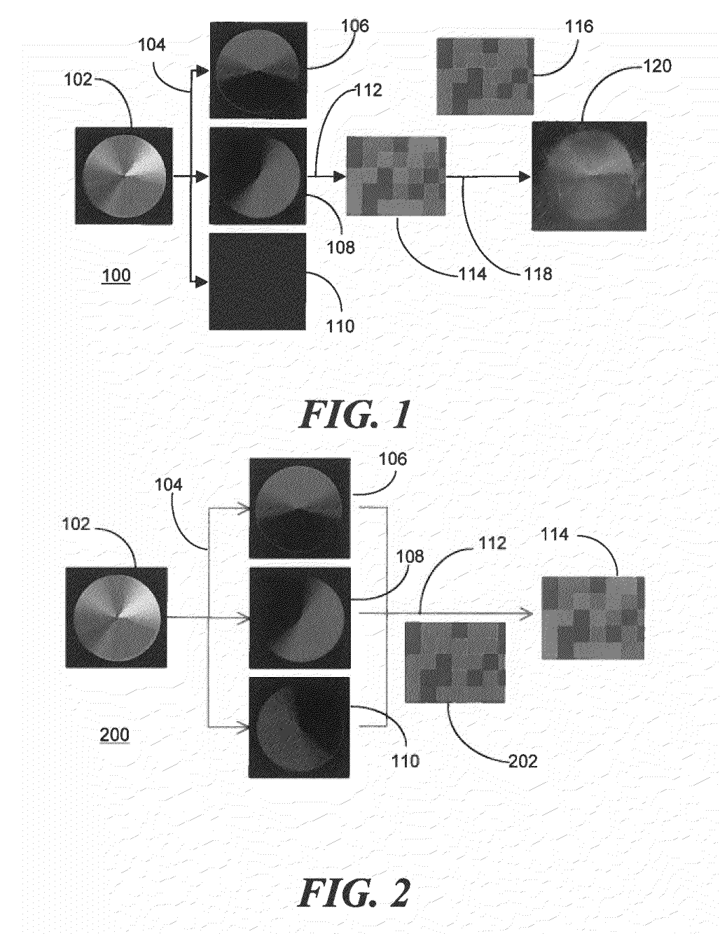

Referring to FIG. 1, a space division multiplexing (SDM) computer generated hologram (CGH) process 100 in accordance with the present embodiment is depicted. As stated above, the process 100 is referred to as a SDM on a single hologram (distributed sub-holograms) process. An image 102 (e.g., a reference color object of a three-dimensional color wheel) is split 104 into its three color component objects 106, 108, 110. In accordance with the SDM process 100, the three color component images 106, 108, 110 and a color selective matrix (the generation of which is discussed below) are utilized to compute 112 CGH information 114. A masked multiplexed color light beam 116 is shined on a spatial light modulator (SLM) operating in response to the CGH information 114, thereby combining 118 each portion of the multiplexed masked color light beam 116 with a location of that portion of the CGH information 114 in order to reconstruct a color holographic display 120 of the object.

Referring to FIG. 2, generation 200 of the CGH information in SDM on single hologram (distributed sub-holograms) in accordance with the present embodiment is illustrated. Generation 112 of the CGH information 114 in accordance with the present embodiment involves splitting 104 intensities of a three-dimensional object's image 102 into its color components 106, 108, 110 and simultaneously computing 112 different holograms or sub-hologram areas of the CGH information 114 (as shown by different color portions in the CGH information 114) in response to the color selective matrix 202. Thus, instead of one color component affecting a whole hologram as described above in regards to the conventional TDM, SDM on multiple holograms and SDM on single hologram (angular selective) processes or affecting one-quarter of a hologram as described above in regards to the conventional SDM on single hologram (three quarters), one color component in the process 100 in accordance with the present embodiment will only affect distributed hologram areas for respective colors. The color selective matrix M(xₕ, yₕ) 202 controls each individual hologram pixel which is affected by a corresponding one of the color components. Therefore, one hologram pixel is only affected by a single color component.

The color selective matrix M(xₕ,yₕ) 202 can be applied to various kinds of CGH algorithms and makes these algorithms suitable to generate holograms for SDM on single hologram (distributed sub-holograms). When computing the value for a hologram pixel, the color component and wavelength specified by matrix position within the color selective matrix M(xₕ,yₕ) 202 for that pixel are used. Examples of color selective matrix 202 generation is described hereinafter in regards to modifications of a conventional CGH algorithm, termed coherent ray trace (CRT), and another CGH algorithm using look-up tables, termed LUTs. The conventional CRT algorithm simulates light prorogation from an object point to a hologram pixel, as shown in equation 1, where I(xₕ,yₕ) is the complex hologram with xₕ,yₕ being its coordinates, N is the total number of object points, aⱼ(xⱼ,yⱼ,zⱼ) is the object point intensity at object point coordinate xⱼ, yⱼ,zⱼ, λ is the wavelength of the reference light beam, Δx equals xₕ−xⱼ, and Δy equals yₕ−yⱼ:

$$I ( {x}_{h} , {y}_{h} ) = {\sum }_{j = 0}^{N - 1} {a}_{j} {e}^{i ( \frac{2 π}{λ} \sqrt{Δ {x}^{2} + Δ {y}^{2} + {z}_{j}^{2}} )} \qquad ( 1 )$$

Combining the CRT with the color selective matrix M(xₕ,yₕ), converts equation 1 to equation 2, where c is one of the colors, λ_{c} is the wavelength of the reference beam for c, and a_{j,c} is the object point intensity for c:

$$I ( {x}_{h} , {y}_{h} ) = {\sum }_{j = 0}^{N - 1} {a}_{j , M ( {x}_{h} , {y}_{h} )} {e}^{i ( \frac{2 π}{{λ}_{M ( {x}_{h} , {y}_{h} )}} \sqrt{Δ {x}^{2} + Δ {y}^{2} + {z}_{j}^{2}} )} \qquad ( 2 )$$

For development of look-up tables (i.e., a horizontal LUT and a vertical LUT) in accordance with the present embodiment, the definition of the horizontal light modulation factor H (Δx,zⱼ) is changed to H (Δx, zⱼ,c) which is defined in equation 3:

$$H ( Δ x , {z}_{j} , c ) = {e}^{i ( \frac{2 π}{{λ}_{c}} \sqrt{Δ {x}^{2} + {z}_{j}^{2}} )} \qquad ( 3 )$$

and the definition of the vertical light modulation factor V (Δy,zⱼ) is changed to V(Δy,zⱼ,c), which is defined in equation 4:

$$V ( Δ y , {z}_{j} , c ) = {e}^{i ( \frac{2 π}{{λ}_{c}} \sqrt{Δ {y}^{2} + {z}_{j}^{2}} )} \qquad ( 4 )$$

In accordance with the present embodiment an off-line pre-computation step computes all possible H (Δx,zⱼ,c) and V(Δy,zⱼ,c) for all combinations of Δx,Δy,zⱼ,c. During computation of holograms in accordance with the present embodiment, for each vertical line (xⱼ,zⱼ), which exists, a_{j,c} (xⱼ,yⱼ,zⱼ)≠0 (i.e. the line is not empty for color c), S(yₕ,c) is computed by equation 5:

S(yₕ,c)=Σⱼ₌₀ⁿ⁻¹a_{j,c}V(Δy,zⱼ,c) (5)

Then the vertical line (xⱼ,z_{J})'s contribution to the final hologram I(xₕ,yₕ)|₍ₓ_{ⱼ}_{,z}_{ⱼ}₎ is computed in accordance with equation 6:

I(xₕ,yₕ)|₍ₓ_{ⱼ}_{,z}_{ⱼ}₎=H(Δx,zⱼ,M(xₕ,yₕ))×S(yₕ,M(xₕ,yₕ)) (6)

Finally, the final hologram I(xₕ, yₕ) is the sum of the contributions from all vertical line as shown in equation 7:

$$I ( {x}_{h} , {y}_{h} ) = \sum I ( {x}_{h} , {y}_{h} ) {\vert}_{( {x}_{j} , {z}_{j} )} \qquad ( 7 )$$

Calculation in accordance with the present embodiment, thus, only utilizes one-third of the computational requirements of the conventional holographic display methods such as TDM or SDM on different holograms.

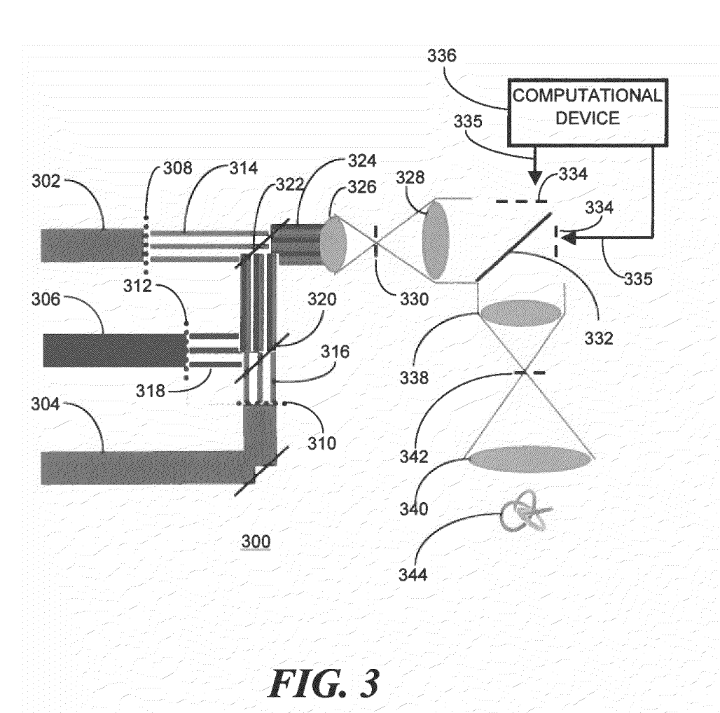

Referring to FIG. 3, a SDM on single hologram (distributed sub-holograms) optical setup 300 in accordance with the present embodiment is depicted. Three component light sources 302, 304, 306 generate and radiate light beams for multiplexing in accordance with the present embodiment. The three component light sources 302, 304, 306 include a red light source 302, a green light source 304 and a blue light source 306. A plurality of light masks 308, 310, 312 act as light modifiers and are coupled to respective ones of the component light sources 302, 304, 306 to generate corresponding modified masked light beams 314, 316, 318. Dichroic mirrors 320, 322 act as beam combiners to color multiplex the modified masked light beams 314, 316, 318 into a modified masked multiplexed light beam 324.

Two lenses 326, 328 and an aperture 330 cooperate to image the modified masked multiplexed light beam 324 through a beam splitter 332 onto an array of a spatial light modulator (SLM) 334, thereby providing portions of the modified masked multiplexed light beam 324 to portions of the array of the spatial light modulator 334. The spatial light modulator (SLM) 334 could, for example, be a SXGA-R3 SLM manufactured by Forth Dimension Displays of Fife, Scotland, UK including a SLM array with a 6400 pixel by 994 pixel array having a 13.86 μm pixel pitch.

The SLM 334 receives computer generated holographic (CGH) information 335 from a computational device 336 which could calculate the CGH information 335, store the CGH information 335, or both. For example, the computational device 336 could be a computer which determines modulation values for a plurality of pixels in a two-dimensional representation of a three-dimensional object in response to locations and color values of each of a plurality of points in the three-dimensional object and generates the computer generated holographic information 335 in response to the locations and color values for each of the plurality of points, the computational device 336 providing each of the modulation values as the computer generated holographic information 335 to corresponding pixels in the SLM 334 pixel array.

The SLM 334 varies modulation of the modified masked multiplexed light beam 324 shined thereon in response to the CGH information 335. In this manner, the SLM 334, utilizing lenses 338, 340 and an aperture 342, creates a color holographic display of an object 344 by reconstructing the object 344 in a reconstructed object space by diffracting portions of the multiplexed masked color light beam 324 at locations in the reconstructed object space determined in response to corresponding portions of the computer generated holographic information 335.

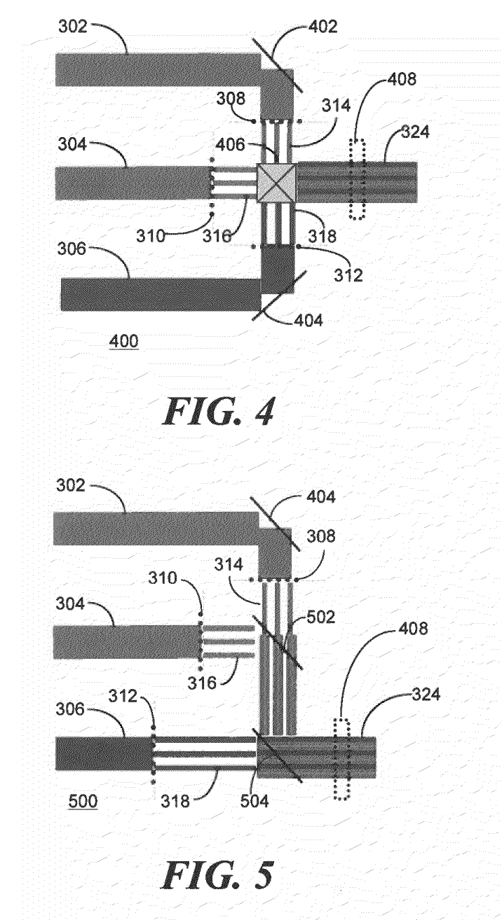

Those skilled in the art will understand that after the computer generated holographic information 335 is generated for a hologram, the computer generated holographic information 335 can be stored, loaded and finally launched to SLM 334 by the computational device 336 for the holographic reconstruction 344 of the three-dimensional object defined by the computer generated holographic information 335. In the SDM on single hologram (distributed sub-holograms) process in accordance with the present embodiment, each sub-hologram needs to be shined with reference light (i.e., a corresponding portion of the modified masked multiplexed light beam 324) which that sub-hologram is computed for. More specifically, pixel (xₕ,yₕ) on the hologram with a color value I(xₕ,yₕ) should be illuminated with light having wavelength λ_{M(x}_{ₕ}_{,y}_{ₕ}₎. On the SLM 334, the pixel matrix M(xₕ,yₕ) forms a colorful pattern (such as the pattern 116 in FIG. 1) in response to the CGH information 335. In order to achieve this, component light beams need to be appropriately masked to form the modified masked multiplexed light beam 324 which only allows pixels M(xₕ,yₕ) appearing at (xₕ,yₕ) on the hologram plane on the SLM 334 pixel array to be shined with appropriate light from the modified masked multiplexed light beam 324. Referring to FIG. 4, an optical setup 400 for multiplexing in accordance with the present embodiment to generate the modified masked multiplexed light beam 324 is depicted.

The three component light sources 302, 304, 306 (including a red light source 302, a green light source 304 and a blue light source 306) generate and radiate light beams for multiplexing in accordance with the present embodiment. The plurality of light masks 308, 310, 312 are coupled to respective ones of the component light sources 302, 304, 306 to generate corresponding modified masked light beams 314, 316, 318 as the light beams from the component light sources 302, 304, 306 pass through the light masks 308, 310, 312. Mirrors 402, 404 reflect the modified masked light beams 314, 316, 318 onto a beam combiner 406 to generate the modified masked multiplexed light beam 324. The beam combiner 406 is an X-beam splitter cube such as the cross dichroic prism X-cube beam splitter manufactured by Nitto Optical Company Ltd. of Tokyo, Japan. The beam combiner 406 advantageously allows the different color masks 308, 310, 312 to be easily adjusted in order to sharply image the modified masked multiplexed light beam 324 on the pixel array surface of the SLM 334 (FIG. 3).

The masking of reference light to generate the modified masked multiplexed light beam 324 can be done either before or after the combining of the different color reference light beams. For masking before combination of the light beams, each color reference light beam from the component light sources 302, 304, 306 is masked by a black and white pattern made for that color (i.e., the masks 308, 310, 312). For masking after combination of the light beams, a band pass filter (alternatively shown in FIG. 4 as filter 408) only allows light with wavelength λ_{M(x}_{ₕ}_{,y}_{ₕ}₎ to pass though at a location in the beam (xₕ,yₕ), and blocks reference light with other wavelengths at that location. For both masking before or after combination of the light beams, the modified masked multiplexed light beam 324 needs to be masked for imaging on the pixel array surface of the SLM 334 in order to reduce cross talk between different colors.

With reference to FIG. 5, an optical setup 500 for multiplexing in accordance with an alternate embodiment to generate the modified masked multiplexed light beam 324 is depicted. Beam combination in the optical setup 500 is accomplished by dichroic mirrors 502, 504 such as dichroic mirrors manufactured by Thorlabs, Inc. of Newton, N.J., USA.

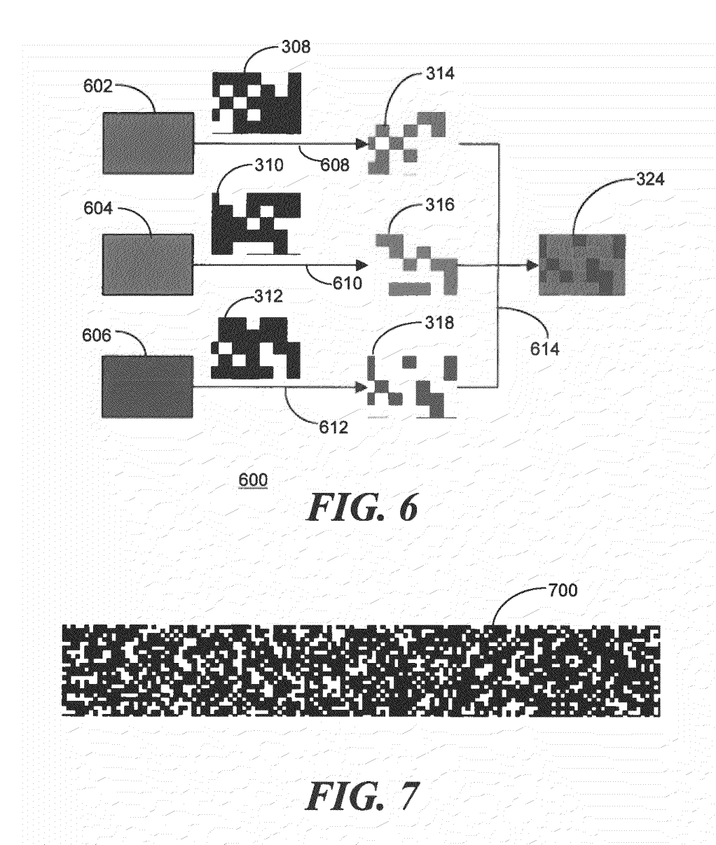

Referring to FIG. 6, a process 600 for masking the component light beams and multiplexing them to form the modified masked multiplexed light beam 324 is depicted. Color component light beams 602, 604, 606 include a red light beam 602, a green light beam 604 and a blue light beam 606. The black and white patterned masks 308, 310, 312 appropriate for each of the color component light beams 602, 604, 606 are placed in the beam path of each of the color component light beams 602, 604, 606 for masking 608. 610, 612 the color component light beams 602, 604, 606 to generate the corresponding modified masked light beams 314, 316, 318. The modified masked light beams 314, 316, 318 are combined 614 (e.g., combined 614 by the X-cube beam combiner 406 (FIG. 4) or the dichroic mirrors 502, 504 (FIG. 5)) to generate the modified masked multiplexed light beam 324. In this manner, Thus, each of the masks 308, 310, 312 selectively allow the corresponding light beams 602, 604, 606 to pass through in order to allow one and only one color to present at each portion of the multiplexed masked multiplexed light beam 324.

While viewing angles resulting from conventional color multiplexing technologies are in a continuous range, the viewing angles resulting from the SDM on single hologram (distributed sub-holograms) process in accordance with the present embodiment is discontinuous. Gaps in the viewing angle range of the SDM on single hologram (distributed sub-holograms) process in accordance with the present embodiment are related to the figure size of the pixels in the M(xₕ,yₕ): i.e., the smaller the figure size, the smaller the gaps in the viewing angle range. If the figure size is small enough such that the gaps in the viewing angle range would be ignored by human eyes, the viewing angle range can be effectively considered as continuous. However, the figure size (which is related to the mask pattern size) cannot be too small and the mask pattern cannot be regular like lines, as both cases will cause deflection by the masks 308, 310, 312 on the reference beams 602, 604, 606 and make a resultant reconstruction unclear. In practice, the figure size is determined, e.g., by trial and error, to be the smallest figure size which can still be made and aligned. This results in a practical range of mask pattern sizes in the range from the size of the SLM pitch to a few millimeters. Referring to FIG. 7, an exemplary black and white mask pattern 700 is depicted.

After shining the modified masked multiplexed light beam 324 masked by M(xₕ,yₕ) to the CGH information 335 (FIG. 3) computed with M(xₕ,yₕ) modulated onto the SLM 334, the three-dimensional object 344 will be reconstructed by correct selection of the color components thereof. If different colors are evenly distributed within M(xₕ,yₕ) with a small figure size, the reconstructed three-dimensional object size and viewing angle range are identical to those of the reconstruction formed by a conventional single color hologram with the same size color. Thus it can be seen that reconstruction size and viewing angle are not compromised by introducing color using the SDM on single hologram (distributed sub-holograms) process in accordance with the present embodiment.

In the SDM on single hologram (distributed sub-holograms) process in accordance with the present embodiment, each component for each color will only affect one third of the final hologram. Thus, the total computational load will advantageously not increase as color is introduced in accordance with the present embodiment. Because only one hologram (i.e., only one hologram of CGH information 335) is used for reconstruction of all colors, the bandwidth and CGH information data storage requirement is the same as single color holography. Further, in the optical setup 300 (FIG. 3), the reconstruction space for each of the different colors are automatically merged with each other and within the same size provided by single color holography. These advantages of the color multiplexing system in accordance with the present embodiment as compared to the conventional color holographic processes described above are summarized in Table 3:

TABLE 3

| Color | CGH | Bandwidth/ | Optical | |
|---|---|---|---|---|
| multiplexing | computation | storage | setup | Reconstruction |
| method | load | requirement | complexity | quality |
| SDM on | 3x | 3x | Complex, | 3 |
| multiple | | | No Sync | reconstruction |
| holograms | | | | spaces, |
| | | | | hard to mix |
| TDM | 3x | 3x | Simple, | Full |
| | | | Need Sync | reconstruction |
| | | | | space, |
| | | | | easy to mix |
| SDM on | 1x | 1x | Simple, | 3 x ¼ |
| single | | | No Sync | reconstruction |
| hologram (3 | | | | spaces, |
| quarters) | | | | hard to mix |
| SDM on | 3x | 1x | Complex, | 3 |
| single | | | No Sync | reconstruction |
| hologram | | | | spaces, |
| (angular | | | | hard to mix |
| selective) | | | | |
| SDM on | Low | Low | Simple, | Full |
| single | | | No Sync | reconstruction |
| hologram | | | | space, |
| (distributed | | | | easy to mix |
| sub- | | | | |
| holograms) | | | | |

After color multiplexing, reconstructions of different color components may not be matched together: a_{j,c} at different positions in the reconstruction three-dimensional space, although all a_{j,c} are computed by the same object coordinates xⱼ,yⱼ, zⱼ in the CGH computation. This mismatch is primarily caused by small diffraction angle differences for different colors, imperfect optical elements and imperfections in other parameters of the optical setup. Color mixing needs to be performed to achieve good color reconstruction quality. The purpose of color mixing is to make color components from the same point of the three-dimensional object, as defined by the CGH information, to appear at the same point in the reconstructed object space.

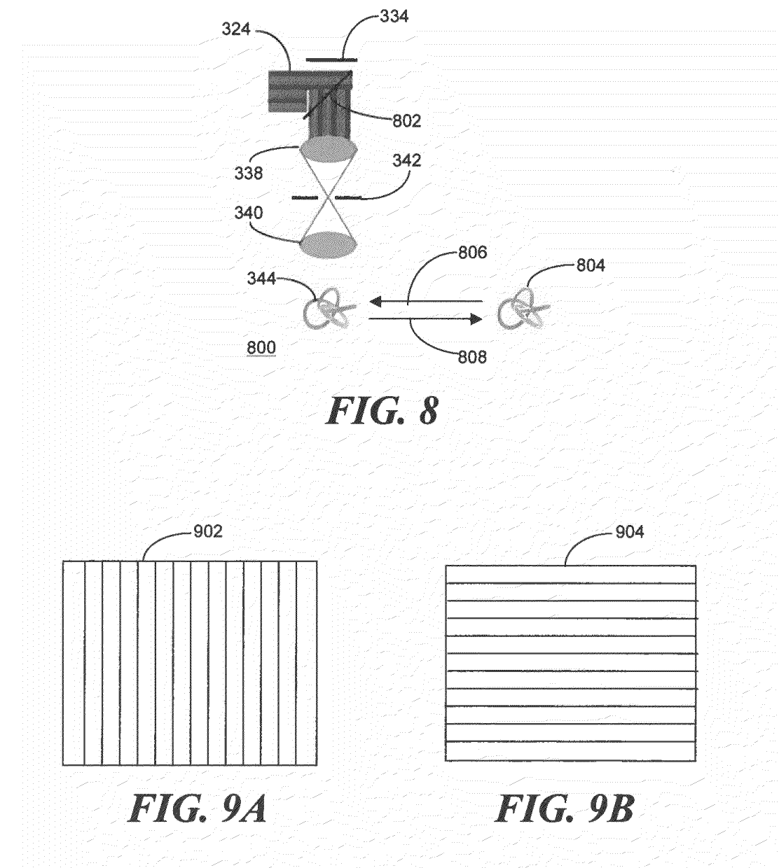

Referring to FIG. 8, a color mixing process 800 for object space correction in accordance with the present embodiment is depicted. The object space correction process 800 color mixes the reconstructed holographic image in order to generate a corrected color reconstruction in the color holographic display. In the object space correction process 800, CGH computation, hologram storage/launching and optics of the holographic display system optical setup are treated as a combined black box. Only the input three-dimensional object space and the final projected three-dimensional reconstruction space are considered. Corrections, like space shift and rescale, are made within the CGH information such that all three-dimensional objects which go into the corrected object space will be automatically corrected for color mixing.

Therefore, as shown in the process 800, the modified masked multiplexed light beam 324 is shined on the pixel array of the SLM 334 after being reflected from a beam combiner 802. The modulated beam is then reflected back through the beam combiner 802 and focused and diffused by the lenses 338, 340 and the aperture 342 to project the reconstructed object 344 in the reconstructed object space. When CGH information corresponding to one or more reference objects 804 is utilized to create the object 344, the one of the one or more reference objects 804 is compared 806 to the reconstructed corresponding reference object 344 and object correction information is generated as horizontal, vertical and depth correction factors in response to object space correction of the color values for each of the plurality of points of the one or more reference images 804. The computational device 336 (FIG. 3) stores the horizontal, vertical and depth correction factors and combines 808 these predetermined factors with uncorrected information corresponding to an object to generate corrected CGH information 335 by color mixing prior to providing the CGH information 335 to the SLM 334 for creation of a reconstructed object 344 in the reconstructed object space.

In order to get the correction parameters/values for object space correction, key depth layers are selected to do depth, column and row correction. The key depth layers could be front, back and center layers or could be a finer depth-division of a reference object. For each kind of correction, an initial correction value/parameter will be initially assigned. Thereafter, holograms of a test pattern are computed as a reference hologram with the correction value/parameter. This reference hologram is launched on the SLM 334 for reconstruction in space. After reconstruction, the correction value/parameter is updated by the difference (e.g., the computed difference 806) between the captured reconstruction 344 of the reference object and the desired outcome reconstruction 804 of the reference object. The test pattern in the CGH information is then computed with the updated correction value/parameter, and further tuning of the correction value/parameter continues until the reconstructed object 344 matches the targeted object 804, or until no further tuning in accordance with the parameters of the system 800 can be done. Column, row and depth corrections are done for selected key depth layers only (e.g., the first, center and the last depth layer). In this manner correction on other layers is automatically generated from correction on these selected key layers.

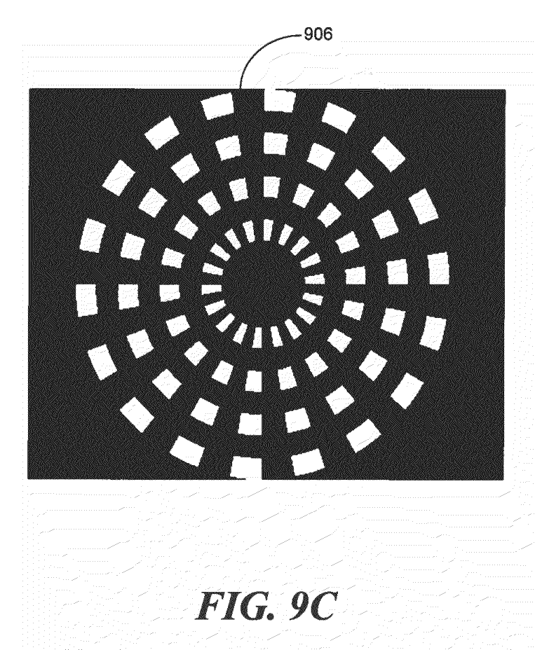

Exemplary reference images in accordance with the present embodiment are depicted in FIG. 9 comprising FIGS. 9A, 9B and 9C. In FIG. 9A, a column reference image 902 is depicted. In FIG. 9B, a row reference image 904 is depicted. And in FIG. 9C, a depth reference image 906 is depicted. In addition to image, a reference color needs to be selected as a target for the correction process 800. In accordance with the present embodiment, the color green is selected to be the reference color because the wavelength of the color green is in the center of the visible light range and because the human eyes are most sensitive to the color green. It will be understood by those skilled in the art that the reference images 902, 904, 906 and the reference color are merely exemplary and other reference images or colors can be used without departing from the spirit of principles taught by the present embodiment.

Column, row and depth correction using the reference images 902, 904, 906 are performed at each selected key depth layer. Initially depth correction at the selected key depth layer is performed, and then column and row correction are performed for the selected key depth layer. The order of the column and row corrections is not important, and either can be performed first.

Depth correction obtains shift values of different colors in the z (depth) direction and causes different color components of selected object layer to appear at the same targeted depth plane during object reconstruction. Thus, the test pattern reference image 906 in accordance with the present embodiment is an object with multiple depth layers. For each iteration, the correction value of the most clear reconstructed layer on the targeted plane (i.e., the plane where the video capturing device is placed or focused upon) during object reconstruction is selected as the center for the next iteration, and smaller depth differences are used between each layer. The iterative computation stops when the center layer of the test pattern appears sharp within a targeted plane in the reconstructed object.

For column correction, the sample column correction pattern 902 contains vertical segments for different colors on the same line. Similarly, for row correction, the sample row correction pattern 904 contains horizontal segments for different colors on the same line. Depth, column and row correction are performed using the testing patterns 906, 902, 904 in order to obtain the correction values/parameters of depth levels, columns and rows, such as the scale and swift in the Z/depth, the scale and swift in the X/horizontal for the columns and the Y/vertical direction for the rows for the targeted depths. Distances between key columns, rows and depth patterns and positions of the first key columns, rows and depth layers are main parameters to be corrected; and positions of key columns, rows and depth layers need to be specified individually, if they do not appear at even distances.

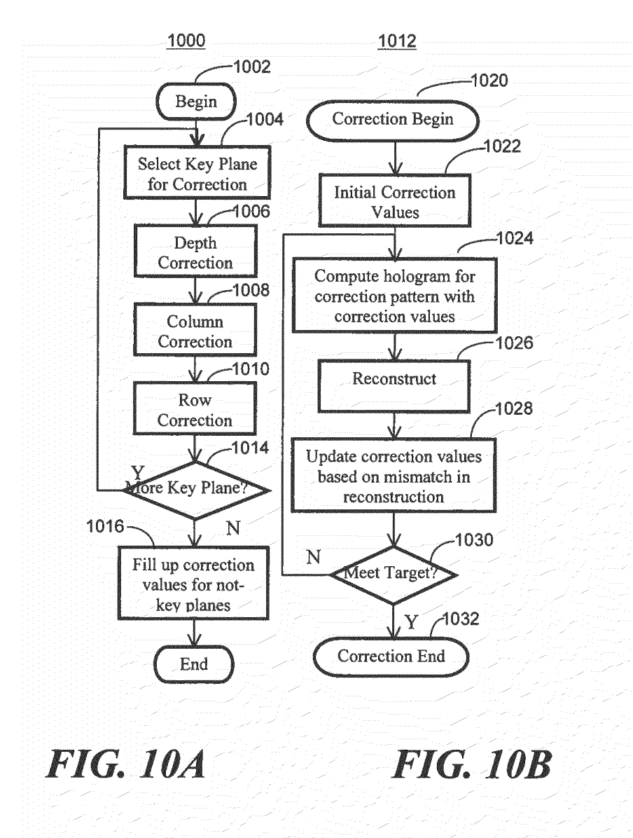

Referring to FIG. 10, including FIGS. 10A and 10B, illustrates a flowchart 1000 of the object space correction process in accordance with the present embodiment. After processing begins 1002, a key plane is selected 1004 for correction. The depth correction 1006, column correction 1008 and row correction 1010 is performed for that key plane as shown in the correction routine flowchart 1012. If there are more key planes 1014, the next key plane is selected 1004 and depth, column and row corrections 1006, 1008, 1010 are performed. When object correction for all of the key planes 1014 is completed, then correction values for non-key planes are filled up 1016 in the color mixing matrix based upon the values determined for the key planes.

The correction process for each of the depth, column and row corrections 1006, 1008, 1010 are performed in accordance with the correction routine 1012. Correction is begun 1020 by assigning initial correction values 1022. The hologram CGH information for the correction pattern is then computed 1024 using the correction values. A color object of the computed correction pattern is reconstructed 1026 and the correction values are updated 1028 based upon the mismatch in the reconstructed correction pattern. If the target mismatch has not been met 1030, processing returns to compute 1024 the hologram CGH information for the correction pattern using the updated correction values and a color object of the computed correction pattern is reconstructed 1026 for updating 1028 the correction values based upon the mismatch in the reconstructed correction pattern. When the target mismatch is met 1030, the correction process is ended 1032 and processing returns to the next step (e.g., step 1008, step 1010 or step 1014).

The object space correction in accordance with the present embodiment is applicable for indirect display techniques like holography, as indirect displays can change output position in response to input parameters without any physical change on the actual display device. Treatment of the correction of all the parameters of the object data process and physical display device as correction of a black box of parameters greatly simplifies the color mixing process. In addition, the correction values are calculated once for each optical setup and stored in a look-up table thereby further simplifying the color mixing process. A comparison of the color mixing process in accordance with the present embodiment and the element-by-element object correction process is shown in Table 4:

TABLE 4

| Color mixing | Analysis | | | Reconstruction |
|---|---|---|---|---|
| method | focus | Nature | Complexity | quality |
| Element-by- | Element | Theoretical | Complex | Accurate |
| element | | | | |
| correction | | | | |
| Color mixing | Input/Output | Experimental | Simple | Good |
| method | | | | |

The bandwidth and storage requirements of different color multiplexing methods for color holographic 3D display are analyzed in Table 2. It can be seen that SDM on single hologram (distributed sub-holograms) has low bandwidth and data storage requirements, the same as other SDM on single hologram methods.

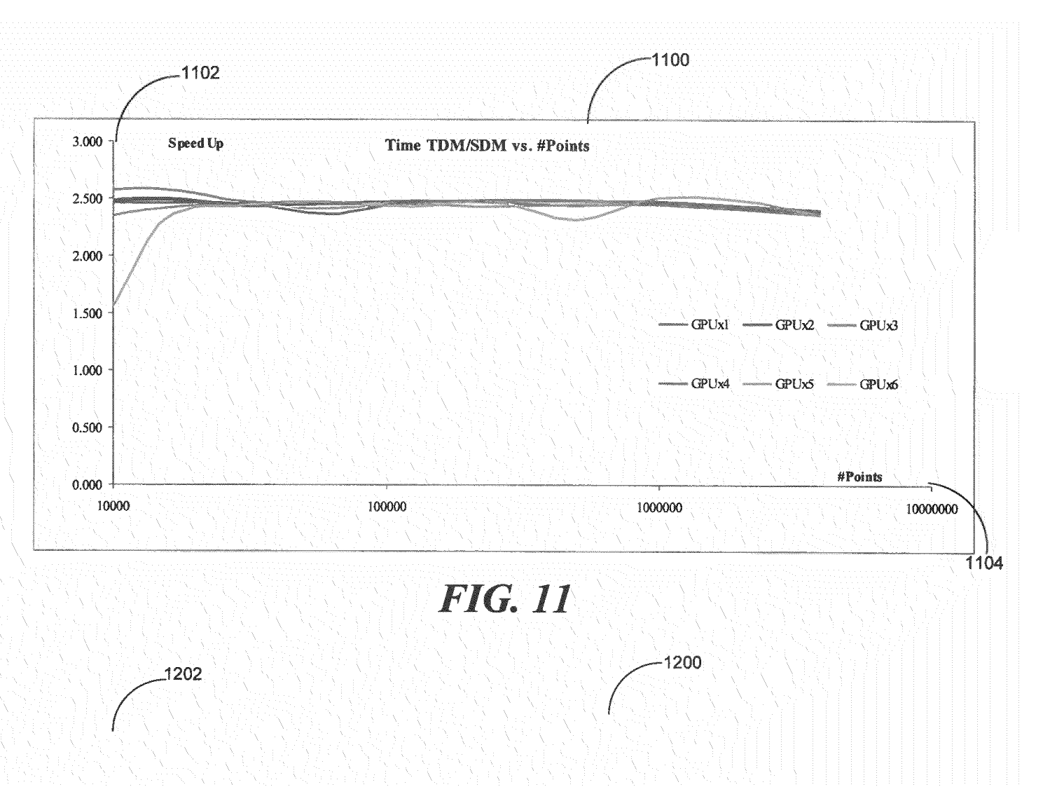

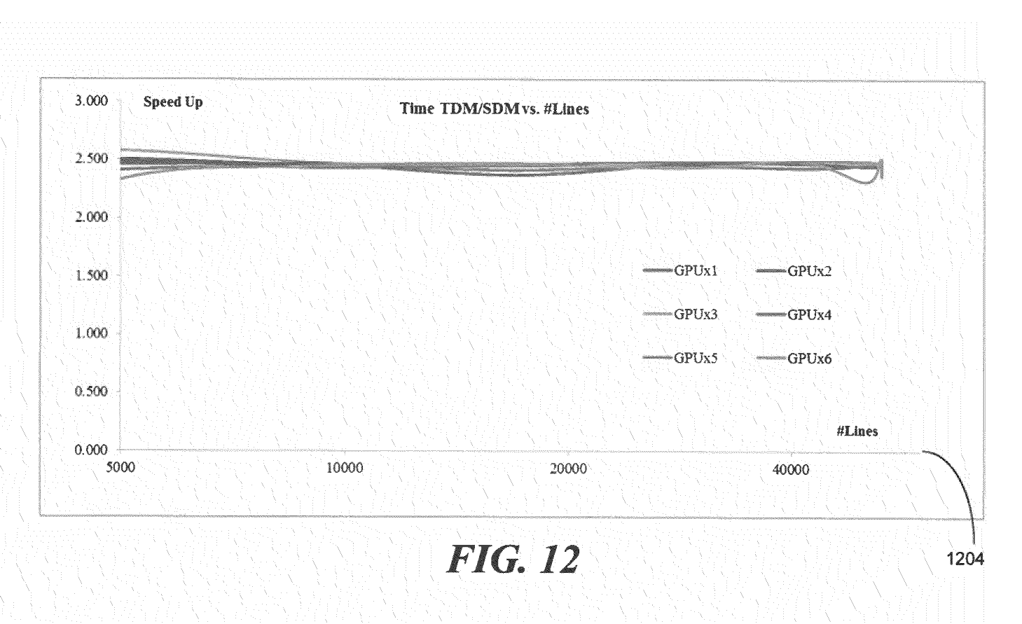

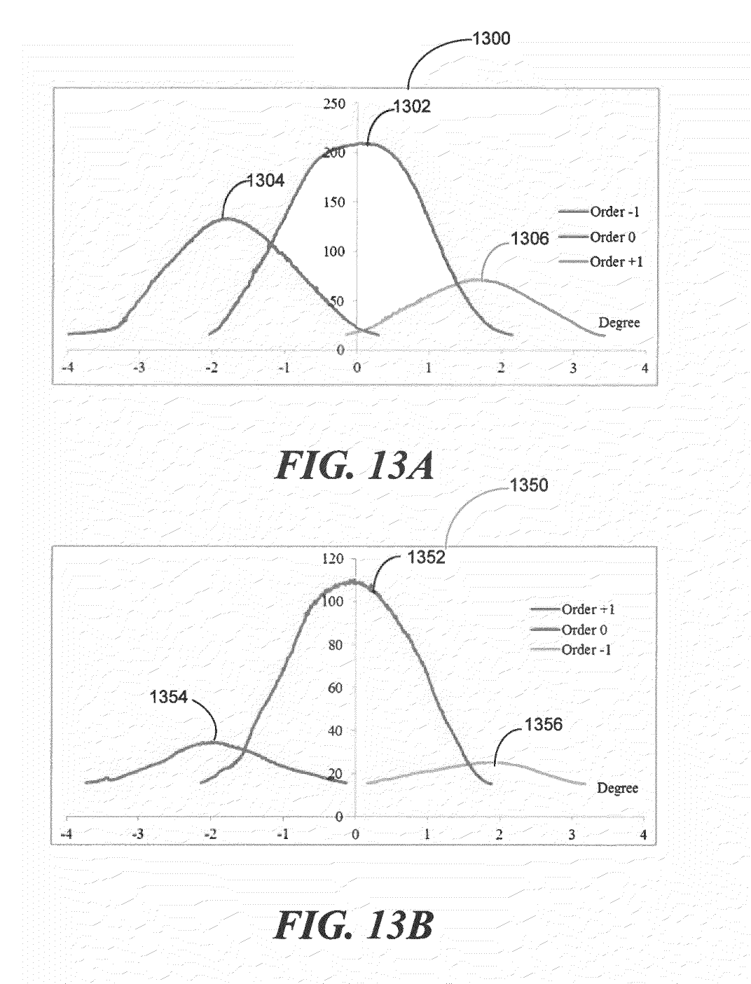

Referring to FIGS. 11 and 12, graphs 1100 and 1200 depict speed up of the generation of CGH information for the same object sets using similar graphic processing unit set-ups for the computational device 336 (FIG. 3) for both conventional TDM and SDM on a single hologram (distributed sub-holograms) in accordance with the present embodiment. Along the x-axis 1102 in graph 1100 the number of points of the object that are computed is plotted, while along the x-axis 1202 in graph 1200 the number of lines of the object that are computed is plotted. Along the y-axis 1104, 1204 the ratio of the time for computation in TDM to the time for computation in SDM on a single hologram (distributed sub-holograms) in accordance with the present embodiment is plotted. Six traces are plotted for each of six different experimental set-ups of graphical computing units (GPUs). It can be seen that a speed-up of SDM on single hologram (distributed sub-holograms) over TDM can achieve up to ˜2.5 times the speed of computation in regards to computing points 1100 or lines 1200. TDM and SDM on multiple holograms have almost the same in point and line requirements or generation of the CGH information, so the comparison of speed up in the graphs 1100, 1200 is also valid for SDM on single hologram (distributed sub-holograms) as compared to SDM on multiple holograms.

Referring to FIG. 13, including FIGS. 13A and 13B, graphs 1300 and 1350 plot reconstruction intensity vs. viewing angle in reconstructed images using the final viewing angle of TDM without a mask in graph 1300 as compared to SDM on single hologram (distributed sub-holograms) with a mask in graph 1350. The data points were obtained by a video camera mounted on an X direction linear stage to capture the reconstruction. A continuous fifteen fps video was shot while the camera was moved at constant speed in the X direction by the stage. After shooting, the video was decomposed into frames and all frames were processed by the same program with the same parameters for reconstruction intensities. The TDM reconstruction of a hologram computed without a color selective matrix and shined with an unmasked green reference beam (graph 1300) is compared to the SDM on single hologram (distributed sub-holograms) reconstruction of a hologram computed with a green color selective matrix and shined with a masked green reference beam (graph 1350). As seen from graphs 1300, 1350, the viewing angle range (in traces 1302, 1352 where the 0 order reconstruction can be seen) of reconstruction from masked hologram and reference beam is similar to that from unmasked hologram and reference beam. It can also be seen that the viewing angle of reconstruction from masked hologram and reference is continuous, as viewed by the camera. It can further be seen that the −1 order reconstruction 1354 and the +1 order reconstruction 1356 of the masked SDM on single hologram (distributed sub-holograms) process are of less intensity than the −1 order reconstruction 1304 and the +1 order reconstruction 1306 of the unmasked TDM process, thereby providing less interference and irregularities from the −1 order reconstruction 1354 and the +1 order reconstruction 1356 of the SDM on single hologram (distributed sub-holograms) process in accordance with the present embodiment as these orders are more blocked by the SDM on single hologram (distributed sub-holograms) process as seen from graph 1350 as compared to the TDM process as seen from graph 1300.

Thus it can be seen that SDM on single hologram (distributed sub-holograms) achieves full color reconstruction space with low CGH computation load, low bandwidth/storage requirements, and simple optical setup design without synchronization. It also can be seen that object space correction in accordance with the present embodiment achieves good reconstruction quality with simple analysis steps and without increasing CGH computation load. While exemplary embodiments have been presented in the foregoing detailed description of the invention, it should be appreciated that a vast number of variations exist, including variations as to the materials and shapes used to form the optical setup 300.

It should further be appreciated that the exemplary embodiments are only examples, and are not intended to limit the scope, applicability, dimensions, or configuration of the invention in any way. Rather, the foregoing detailed description will provide those skilled in the art with a convenient road map for implementing an exemplary embodiment of the invention, it being understood that various changes may be made in the function and arrangement of elements and method of fabrication described in an exemplary embodiment without departing from the scope of the invention as set forth in the appended claims.

What is claimed is:

1. A method for color holographic display comprising:
modifying a plurality of color component light beams by passing light from each of a plurality of color component light sources through a corresponding one of a plurality of color sub-hologram masks to generate a corresponding plurality of modified color component light beams;
multiplexing the plurality of modified color component light beams to generate a multiplexed masked color light beam; and
creating a color holographic display of a three-dimensional object by shining the multiplexed masked color light beam onto modulated computer generated holographic information corresponding to the object in order to reconstruct each point of the object with a color from a portion of the multiplexed masked color light beam and at a location and intensity determined in response to a corresponding portion of the computer generated holographic information.

2. The method for color holographic display in accordance with claim 1 wherein the plurality of color component light beams comprises three color component light beams.

3. The method for color holographic display in accordance with claim 2 wherein the three color component light beams comprise a red light beam, a green light beam and a blue light beam.

4. The method for color holographic display in accordance with claim 1 further comprising generating each of the plurality of color sub-hologram masks as a patterned mask generated to reduce cross-talk between each color component during the step of creating the color holographic display.

5. The method for color holographic display in accordance with claim 4 wherein the step of generating each of the plurality of color sub-hologram masks comprises generating each of the plurality of color sub-hologram masks by randomly selecting the portions of color sub-hologram masks that allow light beams to pass through in order to allow one and only one color to present at each portion of the multiplexed masked color light beam.

6. The method for color holographic display in accordance with claim 1 wherein the step of creating the color holographic display of the object comprises for each predetermined portion of the multiplexed masked color light beam modulating light for that predetermined portion of the multiplexed masked color light beam in response to one or both of the intensity and the phase determined by a corresponding portion of the computer generated holographic information to the location in space determined by the corresponding portion of the computer generated holographic information.

7. The method for color holographic display in accordance with claim 1 further comprising generating the computer generated holographic information in response to the object wherein the object comprises a three-dimensional object.

8. The method for color holographic display in accordance with claim 7 wherein the step of generating the computer generated holographic information comprises generating the computer generated holographic information pixel by pixel in response to points of the three-dimensional object.

9. The method for color holographic display in accordance with claim 7 wherein the step of generating the computer generated holographic information comprises:
generating correction information corresponding to a three-dimensional reconstructed object space; and
object correction of uncorrected object information to generate the computer generated holographic information, and
wherein the step of creating the color holographic display of the object comprises creating the color holographic display of the three-dimensional object in the three-dimensional reconstructed object space.

10. The method for color holographic display in accordance with claim 9 wherein the step of object correction of the uncorrected object information comprises the step of calculating the computer generated holographic information in response to the uncorrected object information and one or more of depth object space correction information, vertical object space correction information and horizontal object space correction information.

11. A method for color holographic display comprising:
combining a plurality of color component light beams from each of a plurality of color component light sources to generate a multiplexed color light beam;
modifying the multiplexed color light beam by filtering the multiplexed color light beam to generate a multiplexed masked color light beam; and
creating a color holographic display of a three dimensional object by shining the multiplexed masked color light beam onto modulated computer generated holographic information corresponding to the object in order to reconstruct the object by diffracting colors of each portion of the multiplexed masked color light beam to a location and at an intensity determined in response to a corresponding portion of the computer generated holographic information.

12. The method for color holographic display in accordance with claim 11 wherein the step of modifying the multiplexed color light beam comprises modifying the multiplexed color light beam by band pass filtering the multiplexed color light beam to allow only a predetermined wavelength of light to pass through at each of a plurality of predetermined locations to generate the multiplexed masked color light beam.

13. The method for color holographic display in accordance with claim 11 wherein the plurality of color component light sources comprises three color component light sources, and wherein the three color component light sources comprise a red component light source, a green component light source and a blue component light source.

14. A method for generating a plurality of points for a color holographic display in a reconstructed object space of a three-dimensional object in a three-dimensional object space comprising:
determining modulation values for each of a plurality of pixels in a two-dimensional representation of the three-dimensional object in response to locations and color intensity values of each of the plurality of points of the object in the three-dimensional object space;
providing the modulation values for each of the plurality of pixels as computer generated holographic information to a spatial light modulator;
combining each of the modulation values with a corresponding predetermined wavelength of light by shining a multiplexed color light beam on the spatial light modulator programmed with the computer generated holographic information in order to generate the color holographic display of the three-dimensional object in the reconstructed object space.

15. The method for generating the plurality of points for the color holographic display in accordance with claim 14 wherein the step of determining the modulation value for each of the plurality of pixels comprises:
object correction of the positions and color intensity values for each of the plurality of points of the three-dimensional object in response to predetermined depth, horizontal and vertical correction factors for generating the modulation value for each of the plurality of pixels; and
determining values for each of the plurality of pixels in the two-dimensional representation of the three-dimensional object.

16. The method for generating the plurality of points for the color holographic display in accordance with claim 14 further comprises before the combining step, generating the multiplexed color light beam by color multiplexing a plurality of modified color component light beams, each of the plurality of modified color component light beams generated by passing light from each of a plurality of color component light sources through a corresponding color sub-hologram mask.

17. A color holographic display system comprising:
a plurality of component light sources;
one or more light modifiers coupled to the plurality of light sources for generating a modified masked multiplexed light beam from light beams generated by and radiated from the plurality of component light sources, wherein the one or more light modifiers comprise one or more light modifiers selected from the group comprising light masks, wavelength bandpass filters, and light beam color multiplexer structures; and
a spatial light modulator for receiving computer generated holographic information and varying modulation of the modified masked multiplexed light beam shined thereon in response to the computer generated holographic information to create a color holographic display of a three-dimensional object by reconstructing the object through modulating the multiplexed masked color light beam at locations within a three-dimensional reconstructed object space determined in response to the computer generated holographic information.

18. The color holographic display system in accordance with claim 17 wherein the one or more light modifiers comprises a plurality of light masks, and wherein each of the plurality of light masks is defined by parameters of the color holographic display system to modify a corresponding light beam from one of the plurality of component light sources.

19. The color holographic display system in accordance with claim 17 wherein the one or more light modifiers comprises a wavelength bandpass filter for modifying the light beams by band pass filtering the light beams to allow only a predetermined wavelength of light to pass through at each of a plurality of predetermined locations to generate the modified masked multiplexed light beam.

20. The color holographic display system in accordance with claim 17 wherein the plurality of component light sources comprises three component light sources.

21. The color holographic display system in accordance with claim 20 wherein the three component light sources comprises a red light source, a green light source and a blue light source.

22. The color holographic display system in accordance with claim 17 further comprising a computational device coupled to the spatial light modulator and generating the computer generated holographic information corresponding to the object.

23. The color holographic display system in accordance with claim 22 wherein the computational device determines a modulation value for a plurality of pixels in a two-dimensional representation of the three-dimensional object in response to locations and color values for each of a plurality of points of the three-dimensional object and generates the computer generated holographic information in response to the locations and color values for each of the plurality of points.

24. The color holographic display system in accordance with claim 23 wherein the computational device determines object correction information in response to parameters of the color holographic display system and generates the computer generated holographic information in response to the locations and color values for each of the plurality of points and the object correction information.

25. The color holographic display system in accordance with claim 24 wherein the computational device determines the object correction information as predetermined depth, horizontal and vertical correction factors in response to object correction of locations for each of a plurality of points of one or more reference objects.
